(19) United States
(12) Patent Application Publication
(10) Pub. No.: US 2013/0150471 A1
(43) Pub. Date: Jun. 13, 2013

(54) CATALYZED EPOXY-CARBOXYLIC ACID SPRAY FOAMS AND METHODS OF USING SAME

(71) Applicant: Owens Corning Intellectual Capital, LLC, Toledo, OH (US)

(72) Inventor: Fatemeh Nassreen Olang, Granville, OH (US)

(73) Assignee: OWENS CORNING INTELLECTUAL CAPITAL, LLC, Toledo, OH (US)

(21) Appl. No.: 13/713,601

(22) Filed: Dec. 13, 2012

Related U.S. Application Data
(60) Provisional application No. 61/570,070, filed on Dec. 13, 2011.

(51) Int. Cl. C08L 63/00

(52) U.S. Cl. CPC C08L 63/00
USPC 521/78; 521/135; 521/81

(57) ABSTRACT

A foamable composition, foamed product and method of forming a foamed product are disclosed. The foamed product includes an epoxy resin crosslinked with a polycarboxylic acid to form a polymeric foam having cells filled with a blowing agent. The reaction between the epoxy resin and the carboxylic acid is catalyzed by a chromium (III) catalyst, particularly an active, carboxylated chromium salt, so as to speed the reaction at ambient temperature to allow the foam to set and cure so rapidly that, when applied to a vertical surface, the effects of gravity do not destroy the foam by pulling it down before the foam sets. Other ingredients preferably include a rheology modifier or thixotrope. The foams may be used for a wide variety of applications including sealing and/or insulating building structures.

### CROSS-REFERENCE TO RELATED APPLICATIONS

This application claims the benefit of U.S. Provisional Application No. 61/570,070, filed Dec. 13, 2011, entitled “Spray Foams Using a Catalyzed Epoxy-Carboxylic Acid Reaction”, which is hereby incorporated herein by reference in its entirety.

### TECHNICAL FIELD

The general inventive concepts relate generally to the field of spray foams such as those used for sealing and/or insulating in building structures, and more specifically to fast-setting foams derived from a catalyzed reaction between epoxy-functional groups and carboxylic acid or carboxyl functional groups.

### BACKGROUND

Spray foams have found widespread use in the fields of insulation and structural reinforcement. For example, spray foams are commonly used to insulate or impart structural strength to items such as automobiles, hot tubs, refrigerators, boats, and building structures. In addition, spray foams are used in applications such as cushioning for furniture and bedding, padding for underlying carpets, acoustic materials, textile laminates, and energy absorbing materials.

A particular problem facing the manufacturer of spray foams—particularly foams used for sealing and insulating building structures—is finding reagents that react quickly enough at low enough temperatures. Foams sprayed on vertical surfaces, such as the cavities between wall-studs, or on under-surfaces, must stay in place long enough for the foams to build and set. If the foaming reaction is too slow relative to the crosslinking reaction, the polymer will crosslink to form a 2-dimensional coating instead of a foam. Eventually, latent gassing may cause ruptures in the cell walls. If the foaming reaction is too fast, the gas all escapes before the polymeric films are formed to capture the gas. A delicate balance of the rate of foaming and the rate of polymerization is required. Even if reactants are initially heated, the foaming and polymerizing must continue when applied to surfaces at ambient temperature at a building location—oftentimes in cold climates.

Most common cavity-filling foams are based on the polyurethanes formed by the rapid reaction of polyvalent isocyanates with polyols. Typically, polyurethane spray foams are formed from two separate components, commonly referred to as an “A” side and a “B” side, that react when they come into contact with each other. The first component, or the “A” side, contains a highly reactive polyvalent isocyanate such as a di-, tri-, or poly-isocyanate that has a high percent of —N═C═O functional groups on the molecule. The second component, or “B” side, contains a nucleophilic reagent that easily attacks the isocyanate carbon. The nucleophilic reagents are generally polyols, primary and secondary polyamines and/or water. Preferably, mixtures of diols and triols are used to achieve the desired speed of reaction and foaming properties. The A- or B-side may further contain silicone-based surfactants, blowing agents, catalysts, and/or other auxiliary agents.

While generally fast reacting, several problems exist with isocyanate-based foams. For example, the “A” side typically contains high levels of toxic methylene-diphenyl-diisocyanate (MOI) monomers. When the foam reactants are sprayed, the MOI monomers form droplets that may be inhaled. Even a brief exposure to these monomers may cause difficulty in breathing; skin irritation; and blistering and/or irritation to the nose, throat, and lungs; and extended exposure can lead to asthmatic-like reactions and possibly death. A further problem is that residual polymeric methylene-diphenyl-di-isocyanate (PMDI) that is not used is considered to be a hazardous waste and must be safely disposed of in a licensed land fill. Such precautions are both costly and time consuming.

In this regard, attempts have been made to reduce or eliminate the presence of isocyanate and/or isocyanate emission by spray foams into the atmosphere. For example, U.S. Patent Publication No. 2006/0047010 to O'Leary describes a polyurethane spray foam that is formed by reacting an isocyanate prepolymer composition (containing less than about 1 wt % free isocyanate monomers) with an isocyanate-reactive composition. Also, aqueous latex foams have been described in U.S. Patent Publication Nos. 2008/0161430; 2008/0161431; 2008/0161433; 2008/0161432; 200910111902; and 2010/0175810 to Korwin-Edson et al. These aqueous latex foams employ functionalized resins, such as carboxylated acrylic resins, which react rapidly with polyfunctional aziridines. In another approach, alkylcyclocarbonates have been reacted with polyamines to form urethane bonds (see, e.g., Rappoport, et at, U.S. Pat. No. 5,175,231).

Other approaches to foams have been described, but their usefulness as rapidly-setting foams in building structure applications is lacking. For example, U.S. Pat. No. 6,890,964 to Czaplicki et al. describes an epoxy-based foam-in-place material that is homopolymerized by an acid catalyst, preferably phosphoric acid, which involves a great deal of exothermic heat Also, U.S. Pat. No. 6,479,560 to Freitag et al. describes an epoxy-based foam with an acid curing agent. Data presented in the '560 patent suggests reactions times from a few seconds to about 5 minutes, but at temperatures of about 200 to more than 300° F. (FIG. 1 and certain examples). Epoxy resins have also been cured with polyamines. See, e.g., U.S. Pat. No. 4,593,056 to Quershi et al. and U.S. Patent Publication No. 2011/0042843A1 to Dixit et al.

U.S. Pat. No. 6,359,147 to Rindone et al. describes a series of chromium (III) carboxylates that are useful as catalysts for reactions with certain ring systems. For example, the catalysts are said to promote the reaction of aziridines with carboxylic acids and anhydrides; the reaction of oxetanes with anhydrides, carboxylic acids and imides; and the reaction of hydroxyl compounds with anhydrides, lactones, and carbonate esters. Additionally, the catalyst is said to accelerate the reaction of certain 3-member rings with certain reactants: the reaction of oxirane or aziridine with lactones was accelerated; the reaction of oxirane or aziridine with carbonate esters was accelerated; and the reaction of thiranes with anhydrides was accelerated. However, the catalysts did not accelerate the reaction of thiranes with carboxylic acids; or the reaction of tetrahydrofurans with carboxylic acids.

U.S. Pat. No. 4,017,429 to Steele et al. describes catalytically active chromium (III) tricarboxylate hydrates that are capable of catalyzing the reaction between certain oxirane compounds and carboxylic acids at a wide range of temperatures.

Despite these improvements in eliminating isocyanate monomers from spray foam chemistry, there remains a need in the art for fast reacting foams that will foam and cure quickly enough to withstand gravity and be able to be effectively applied to and set on vertical surfaces.

### SUMMARY

Disclosed embodiments provide foamable compositions and methods for use thereof. The foamable compositions include epoxide-containing resins reactive with carboxylic and polycarboxylic acids. The reaction between the two is catalyzed by a chromium (III) catalyst (also included in the compositions) which catalyzes the reaction between the acid and the epoxide to allow for crosslinking to form the foam at ambient temperature.

In a first exemplary embodiment, a two part foamable composition is provided. The composition may be a foam-in-place composition. The composition comprises a first part comprising an epoxy resin; and a second part comprising a polycarboxylic acid crosslinking agent, and a chromium III catalyst complex capable of catalyzing a reaction between the epoxy resin and the polycarboxylic acid at ambient temperature. The composition further comprises a blowing agent for initiating a foaming reaction.

In a second exemplary embodiment, a method of sealing or insulating part of a building is provided. The method comprises applying a two-part foamable composition, as described above, to the part of the building, initiating a foaming reaction, and permitting the polycarboxylic acid and the epoxy resin to covalently react to form a foam.

In a third exemplary embodiment, a foam product is provided. The foam product comprises cells formed from the reaction product of an epoxy resin crosslinked to a polycarboxylic acid crosslinking agent, wherein the polycarboxylic acid crosslinking agent is a polyacrylic acid; and a blowing agent disposed within at least some of the cells, wherein the reaction between the epoxy resin and the polycarboxylic acid crosslinking agent is catalyzed by a chromium (III) catalyst.

In certain other exemplary embodiments according to the first, second and third embodiments, the epoxy resin comprises an aliphatic backbone, which may be selected from polyester backbones or polyether backbones. In other exemplary embodiments, the epoxy resin comprises an aromatic backbone. The polycarboxylic acid may be a polyacrylate. Typically, the epoxy resin and acid are used in amounts that produce a ratio of acid functional groups to epoxide functional groups of 1 or slightly higher; for example, generally from 0.9 to 1.2, and more specifically from 1.0 to 1.1. In some exemplary embodiments, the blowing agent is a low-boiling point hydrocarbon, such as one selected from FEA-1100 and HFC 254. In some exemplary embodiments, the composition further comprises a rheology modifier, such as an associative thickener, a cellulosic derivative, an inorganic clay, a polyamide, and combinations thereof.

In the exemplary method described above, the part of the building to which the two-part composition is applied can be a seam or crevice between two structural components. It could also be a cavity or open space framed by structural components. Application may be carried out in any suitable manner including, for example, by rolling, spraying, brushing, extruding, etc. Heat may be applied to the reactants at the time of application, but once applied to the substrate, the foam reaction proceeds at ambient temperature, that is without any continued application of heat. The foamed product cures to the touch in a very short time frame, for example, less than 180 seconds, less than 120 seconds, or less than 90 seconds. In some exemplary embodiments, the foams produced have a high percentage of closed cells, for example, greater than 80%, greater than 85%, greater than 90%, or greater than 95% closed.

A common feature typically encompassed by the foams of the general inventive concepts is the ability to seal and insulate vertical substrates at ambient conditions with a foam that stays in place on a vertical substrate for a duration sufficient to resist gravity long enough and build strength quickly enough to produce a useful insulation foam that does not run down the vertical substrate.

Other exemplary advantages and features of the general inventive concepts will become more evident from the following detailed description.

### DETAILED DESCRIPTION

In a first exemplary embodiment, a two part foamable composition is provided. The composition may be a foam-in-place composition. The composition comprises a first part comprising: an epoxy resin; and a second part comprising a polycarboxylic acid crosslinking agent, and a chromium III catalyst complex capable of catalyzing a reaction between the epoxy resin and the carboxylic acid at ambient temperature. The composition further comprises a blowing agent for initiating a foaming reaction.

In a second exemplary embodiment, a method of sealing or insulating part of a building or other similar structure is provided. The method comprises applying a two-part foamable composition, as described above, to the part of the building or structure, initiating a foaming reaction, and permitting the polycarboxylic acid and the epoxy resin to covalently react to form a foam.

In a third exemplary embodiment, a foam product is provided. The foam product comprises cells formed from the reaction product of an epoxy resin crosslinked to a polycarboxylic acid crosslinking agent, wherein the polycarboxylic acid crosslinking agent is a polyacrylic acid; and a blowing agent disposed within at least some of the cells, wherein the reaction between the epoxy resin and the polycarboxylic acid crosslinking agent is catalyzed by a chromium (III) catalyst.

In certain other exemplary embodiments according to the first, second and third exemplary embodiments, the epoxy resin comprises an aliphatic backbone, which may be selected from polyester backbones or polyether backbones. In other exemplary embodiments, the epoxy resin comprises an aromatic backbone. The polycarboxylic acid may be a polyacrylate or polyacrylic acid. Typically, the epoxy resin and acid are used in amounts that produce a ratio of acid equivalent to epoxide equivalent of 1 or slightly higher, for example, generally from 0.9 to 1.2, and more specifically from 1.0 to 1.1. In some exemplary embodiments, the blowing agent is a low-boiling point hydrocarbon, such as one selected from FEA-1100 and HFC 254. In some exemplary embodiments, the composition further comprises a rheology modifier, such as an associative thickener, a cellulosic derivative, an inorganic clay, a polyamide, and combinations thereof.

In the exemplary method described above, the part of the building or structure to which the two-part composition is applied can be a seam or crevice between two structural components; it may also be a cavity or open space framed by structural components. Application may be carried out in any suitable manner including, for example, by rolling, spraying, brushing, extruding, etc. Heat may be applied to the reactants at the time of application, but once applied to the substrate, the foam reaction proceeds at ambient temperature, that is without any continued application of heat. The foamed product cures to the touch in a very short time frame, for example, less than 180 seconds, less than 120 seconds, or less than 90 seconds. In some exemplary embodiments, the foams produced have a high percentage of closed cells, for example, greater than 80%, greater than 85%, greater than 90%, or greater than 95% closed.

A common feature typically encompassed by the foams of the general inventive concepts is the ability to seal and insulate vertical substrates at ambient conditions with a foam that stays in place on a vertical substrate for a duration sufficient to resist gravity long enough and build strength quickly enough to produce a useful insulation foam that does not run down the vertical substrate.

Unless defined otherwise, all technical and scientific terms used herein have the same meaning as commonly understood by one of ordinary skill in the art to which the disclosure pertains. Although other methods and materials similar or equivalent to those described herein could be used in the practice or testing of the disclosed exemplary embodiments, the exemplary methods and materials described herein are believed to sufficiently illustrate the general inventive concepts. All references cited herein, including books, journal articles, published U.S. or foreign patent applications, issued U.S. or foreign patents, and any other references, are each incorporated by reference in their entireties, including all data, tables, figures, and text presented in the cited references.

When referring to the exemplary compositions and products disclosed herein, it should be understood that the discussion relating to the exemplary compositions and products is equally applicable to such exemplary compositions and products used in the disclosed exemplary methods.

Unless otherwise indicated, all numbers expressing ranges of magnitudes, such as angular degrees, quantities of ingredients, properties such as molecular weight, reaction conditions, dimensions and so forth as used in the specification and claims are to be understood as being modified in all instances by the term “about.” Accordingly, unless otherwise indicated, the numerical properties set forth in the specification and claims are approximations that may vary depending on the desired properties sought to be obtained in the disclosed embodiments. Notwithstanding that the numerical ranges and parameters setting forth the broad scope of the disclosed embodiments are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

As used herein, the term “foam-in-place” refers to compositions or systems which are applied in the field. That is, the compositions are mixed and react to form a foam on or in proximity to the intended substrate within a short period of time. In certain exemplary embodiments, the compositions react at ambient temperature (i.e. 18-25° C.) and in the absence of added heat. In certain exemplary embodiments disclosed herein, the foams cure/harden to the touch within a few minutes or less.

### Epoxy Resins

Various exemplary embodiments disclosed herein relate to novel, fast-setting foamable compositions and foams that can be used in building construction as sealants and/or insulation.

As previously discussed, the first part of these exemplary foams include an epoxy resin. The epoxy resins which are useful in the disclosed exemplary embodiments include those epoxy resins familiar to those skilled in the art. The properties of such conventional epoxy resins are described, for example, in the chapter entitled “Epoxy Resins” in the Second Edition of the Encyclopedia of Polymer Science and Engineering, Volume 6, pp. 322-382 (1986). While not limited thereto, the epoxy resins of the disclosed exemplary embodiments normally have epoxy equivalent weight values of from 100 up to 4000 or higher and, on average, the epoxy resin or mixture of epoxy resins has from 1.5 to 4.5, and more typically from 1.5 to 3, epoxide functional groups per molecule. The epoxy resin may have a viscosity of from 5,000 to 100,000 cps (Brookfield viscosity) at 21° C., and a specific gravity of from 1.0 to 1.4. The epoxy resin may be a liquid and may further comprise a high viscosity resin with relatively low reactivity which in part may be used to reduce or control any resulting exotherm from the reaction between the epoxy resin and the polycarboxylic acid.

Epoxy resins may include aliphatic backbones, aromatic backbones, or mixtures thereof. The epoxy backbones may include polyethers or polyesters. Exemplary epoxy resins which could be utilized in the embodiments encompassed by the general inventive concepts include: (a) polyglycidyl ethers obtained by reacting polyhydric phenols such as bisphenol A, bisphenol F, bisphenol AD, catechol, resorcinol, hydroquinone, pyrocatechol, saligenin and phloroglucinol, or polyhydric alcohols such as glycerin and polyethylene glycol with haloepoxides such as epichlorohydrin; (b) glycidylether esters obtained by reacting hydroxycarboxylic acids such as p-hydroxybenzoic acid or beta-hydroxy naphthoic acid with epichlorohydrin or the like; (c) polyglycidyl esters obtained by reacting polycarboxylic acids such as phthalic acid, tetrahydrophthalic acid or terephthalic acid with epichlorohydrin or the like; (d) epoxidated phenolic-novolac resins (sometimes also referred to as polyglycidyl ethers of phenolic novolac compounds); and (e) epoxidated polyolefins, glycidylated aminoalcohol compounds and aminophenol compounds, hydantoin diepoxides and urethane-modified epoxy resins. Mixtures of epoxy resins may also be used in various exemplary embodiments as well. For example, mixtures of liquid (at ambient temperature) and semisolid, and/or solid epoxy resins could be used, particularly solvated solid epoxy resins. These and many other epoxy resins are available commercially, for example, under the trade name “Epon Resins” from the Shell Chemicals Company, “Araldrite Resins” from the Ciba Company, “DER Resins” from the Dow Chemical Company, and “Unox Epoxides” or “ERL” epoxides from Union Carbide Chemicals Company.

A resin or resin mixture may constitute from 20 to 95% by weight and, in some instances, from 30 to 90% by weight of the composition of an exemplary embodiment, depending on its equivalent number.

### Carboxylic Acid Compounds

A second component of the exemplary foams of the disclosed embodiments is a polycarboxylic acid compound containing two or more carboxylic acid functional groups, for example, di-, tri-. and polycarboxylic acids. The polycarboxylic acid may also be referred to herein as a “polycarboxylic acid crosslinking agent.” As used herein, the term crosslinking agent refers to a chemical compound which is covalently linked into a polymer structure, and often is crosslinked between two or more monomers having compatible functional groups. For example, in the exemplary embodiments disclosed herein, a polycarboxylic acid crosslinking agent may react with one or more epoxide functional groups from one or more epoxy resin molecules, and is thus crosslinked into the structure. This is in contrast to “curing” agents such as catalysts or the like, which are not actively or covalently part of the polymer structure after reaction.

The polycarboxylic acid compound may be saturated or unsaturated aliphatic, aromatic, heterocyclic, monomeric, and/or polymeric in nature. The polycarboxylic acid compound may also contain noninterfering groups other than carboxylic acid as substituents on the organic backbone. Nonexclusive examples of suitable acids include citric acid, citroconic, oxalic acid, tartaric acid, succinic acid, fumaric acid, adipic acid, maleic acid, malonic acid, glutaric acid, phthalic acid, metaphosphoric acid, or salts that are convertible into an acid that is an alkali metal salt of citric acid, tartaric acid, succinic acid, fumaric acid, adipic acid, maleic acid, oxalic acid, malonic acid, glutaric acid, phthalic acid, metaphosphoric acid, or mixtures thereof. Nonexclusive examples of salts which are convertible into acids include aluminum sulfate, calcium phosphate, alum, a double salt of an alum, potassium aluminum sulfate, sodium dihydrogen phosphate, potassium citrate, sodium maleate, potassium tartrate, sodium fumarate, sulfonates, and phosphates.

The polycarboxylic acid may also be a polyfunctional polymeric acid. These include carboxy functional polyesters, carboxyterminated polyolefins (e.g., polybutadiene), carboxy terminated polyethers such as the succinic acid half ester of polyether glycols, and dimerized and trimerized fatty acids. Polyacrylic acid such as QRXP 1676 available from Rohm & Haas is another example.

The polycarboxylic acid may be present in an amount from 1 to 60 percent by weight of the dry foamable composition, and in some instances in an amount from 3 to 50 percent by weight, depending on its equivalent weight. According to the general inventive concepts, it is typically desirable to balance the relative amounts of resin and acid based on their functionality equivalence. Epoxy resins and polycarboxylic acids have multiple functional groups and this is acknowledged by the term “equivalent weight,” which is the number of grams of the compounds that contains one gram equivalent of the functionality, either epoxide or acid. Thus, when the ratio of acid equivalent to epoxide equivalent is near 1, there are approximately the same number of acid groups to react with epoxide groups. For example, the ratio of acid equivalent to epoxide equivalent may be from 0.9 to 1.2, and in some instances from 1.0 to 1.1.

### Blowing Agents

As discussed herein, the foamable compositions also comprise a blowing agent. A blowing agent is a compound or composition that is capable of generating a gas under the reaction conditions. Generally, suitable blowing agents will have relatively low boiling points (relative to ambient application conditions), and are well known to those skilled in the art. In some exemplary embodiments, it is acceptable if a small amount of heat is applied to achieve boiling and gas generation. In these exemplary embodiments, the heat may be supplied internally from exothermic crosslinking reactions and/or externally from heating equipment like spray guns or other application devices. Any suitable blowing agent or combination of blowing agents may be used in the practice of the general inventive concepts. Blowing agents useful in the practice of the practice of various exemplary embodiments may be selected from: 1) organic blowing agents, such as aliphatic hydrocarbons having 1-9 carbon atoms (including, for example, methane, ethane, propane, n-butane, isobutane, isopentane, n-pentane, isopentane, neopentane, and cyclopentane) and fully or partially halogenated aliphatic hydrocarbons having 1-4 carbon atoms (see below) and aliphatic alcohols, ketones, esters and ethers having 1-3 carbon atoms (e.g., methanol, ethanol, n-propanol, and isopropanol; and acetone, methylformate, and dimethylether); 2) inorganic blowing agents, such as carbon dioxide (either dissolved in the mixture or generated via reaction between two components, such as an acid and a carbonate), nitrogen, water, air, argon, nitrogen, and helium; and 3) chemical blowing agents, such as azodicarbonamide, azodiisobutyro-nitrile, benzenesulfonhydrazide, 4,4-oxybenzene sulfonylsemicarbazide, p-toluenesulfonyl, p-toluene sulfonyl semi-carbazide, barium azodicarboxylate, N,N′-dimethyl-N,N′-dinitrosoterephthalamide, and trihydrazinotriazine.

Exemplary halogenated aliphatic hydrocarbon blowing agents include “Freon-like” fluorocarbons, chlorocarbons, and chlorofluorocarbons. Examples of partially or fully halogenated fluorocarbons include methyl fluoride, difluoromethane (HFC-32), perfluoromethane, ethyl fluoride (HFC-16I), 1,2-difluoroethane (HFC-142), 1,1difluoroethane (HFC-1S2a), 1,1,1-trifluoroethane (HFC-143a), 1,1,1,2-tetrafluoro-ethane (HFC-134a), 1,1,2,2-tetrafluoroethane (HFC-134), pentafluoroethane (HFC-12S), perfluoroethane, 2,2-1-fluoropropane (HFC-272fb), 1,1,1-trifluoropropane (HFC-263fb), 1,1,1,3,3-pentafluoropropane (HFC 24Sfa), 1,1,1,2,3,3,3-heptafluoropropane (HFC-227ea), perfluoropropane, 1,1,1,3,3-pentafluorobutane (HFC-36Smfc), perfluorobutane, and perfluorocyclobutane. Examples of partially halogenated chlorocarbons and mixed chlorofluorocarbons for use in various exemplary embodiments include methylchloride, methylenechloride, chlorodifluoromethane (HCFC-22), ethylchloride, 1,1,1-trichloroethane, 1,1,1 trifluoroethane, 1,1-dichloro-1-fluoroethane (HCFC-141b), 1-chloro-1,1-difluoroethane (HCFC-142b), 1,1-dichloro-2,2,2-trifluoroethane (HCFC-123) and 1-chloro-1,2,2,2 tetrafluoroethane (HCFC-124), pentafluoroethane, dichloropropane, and the like. Examples of fully halogenated chlorofluorocarbons include trichloromonofluoromethane (CFC-II), dichlorodifluoromethane (CFC-12), trichlorotrifluoroethane (CFC-II3), dichlorotetrafluoroethane (CFC-114), chloroheptafluoropropane, dichlorohexafluoropropane, and HFC-24Sfa.

Particularly useful blowing agents include 1-chloro-1,1-difluoroethane (HCFC-142b), 1,1,1,2-tetrafluoro-ethane (HFC-134a), carbon dioxide, and 1,1-difluoroethane (HFC152a); and blends of these: e.g., HCFC-142b with carbon dioxide, HFC-134a with carbon dioxide, carbon dioxide with ethanol, carbon dioxide with water, and HFC-134a with HFC152a. In one exemplary embodiment, about 50% of the HFC-134a blowing agent and 50% of the HFC-152a blowing agent may be present in the composition. Another blowing agent, FEA-II 00, is a fourth generation fluorocarbon product available from DuPont. According to properties described in a white paper authored by Loh et al., FEA-1100 has shown very low global warming potential, has shown zero ozone depletion potential, is non-flammable and stable at ambient temperatures, and has a higher boiling point than HFC 245fa making it safer and easier to work with.

It is to be appreciated that any of the blowing agents suitable for use in the foamable composition can be used singly or in any combination thereof. In some exemplary embodiments, the blowing agent may be present in an amount from 8 to 40 percent by weight of the composition, and in other exemplary embodiments, in an amount from 15 to 30 percent by weight.

### Chromium Catalysts

For many of the disclosed exemplary embodiments, the epoxy-carboxylic acid polymerization reaction is generally not sufficiently fast at ambient temperature to be entirely useful without a catalyst. Accordingly, as previously mentioned, various disclosed exemplary embodiments may comprise a chromium catalyst. Chromium (III) catalysts are suitable examples, and are to be differentiated from hazardous Chromium (VI) compounds. In certain exemplary embodiments, the chromium catalyst is present in the second part of the composition. Chromium (III) complex ions tend to adopt octahedral molecular geometry, with six ligands. The colors of these solutions changes according to the ligands attached to the Cr, and according to the cis or trans nature of the ligand attachments. For example, a commercially available chromium (III) chloride hydrate is the dark green complex [CrCl₂(H₂O)₄]Cl, but two other forms are known: the ale green complex [CrCl(H₂O)₆]Cl₂, and the violet complex [Cr(H₂O)₆]Cl₃. If water free green chromium (III) chloride is dissolved in water, the green solution turns violet after some time due to the substitution of water for chloride in the inner coordination sphere.

The octahedral nature of chromium coordinate complexes implies six ligands, as suggested by the formulae above. However, stable complexes and salts of chromium (III) with three ligands (e.g. tricarboxylates) have been prepared by driving off water molecules from the hydrated species in the presence of acid. The color varies from the original blueviolet through blue to green in the activated tri-carboxylate. In mixtures of partially hydrated species, the catalytic capability is proportional to the amount of green material present. The ratio of active to inactive catalyst in this mixture can be measured spectrophotometrically by determining the ratio of the carbonyl absorption at 1615 cm⁻¹ to the carbonyl absorption at 1540 cm⁻¹. This has been described in U.S. Pat. No. 4,017,429 to Steele et al., which is herein incorporated in its entirety by reference.

The anion (negatively charged) portion of the catalyst is also critical to its activity in the sense that it may not cause complete coordination. For example, if the carboxylate anion is replaced by the acetylacetonate anion the resulting chromium III acetylacetonate will be catalytically inactive. The reason for this is that the acetylacetonate groups effectively occupy all of the chromium III coordination sites. The same inactivity occurs if the active chromium III tricarboxylate is contacted with a non-charged specie such as ethylene diamine to form the ethylene diamine complex of the salt. While not intending to be bound by any theory, it is speculated that the carboxyl function of carboxylates—which can be resonance stabilized in two tautomeric forms that “share” the negative charge—is capable of combining with two ligand-binding sites of the octahedral chromium complex.

The catalyst used in many the disclosed exemplary embodiments is a Cr⁺³ carboxylate salt, wherein the salt is a C3-C60, straight or branch-chained, aryl, alkyl, or aralkyl carboxylate, such as those described in U.S. Pat. No. 6,359,147 to Rindone et al. For purposes of this application, an “aryl” group is defined as being derived from an aromatic hydrocarbon typically with 6 to 20 carbon atoms, or 6 to 16 carbon atoms, having a single ring (e.g., phenyl), or two or more condensed rings (e.g., naphthyl), or two or more aromatic rings which are linked by a single bond (e.g., biphenyl). The aryl group may optionally be mono-, di-, or tri-substituted, independently, with lower branched or straight chain alkyl, lower cycloalkyl with 3 to 12 carbon atoms, lower branched or straight chain alkoxy, lower cycloalkoxy with 3 to 12 carbon atoms, fluoro, chloro, bromo, trifluoromethyl, cyano, nitro, and/or difluoromethoxy, and so forth. The Cr⁺³ carboxylate of the exemplary embodiments may optionally be a hexanoate, pentanoate, 2-ethylhexanoate, oleate, stearate, toluate, cresylate, benzoate, alkylbenzoate, alkoxybenzoate, napthanate, alkoxide, acetate, butyrate, propionate, octoate, and decanoate. In some exemplary embodiments, the Cr⁺³salt is a C3-C10, straight or branch-chained, aryl, alkyl, or aralkyl carboxylate, such as acetate, butyrate, propionate, benzoate, octoate, and decanoate. Some commercially available Cr⁺³salt catalysts include HYCAT™ 2000S and HYCAT™ OA.

The catalyst can be used as a pure compound or may instead be used with a solvent or diluent, such as an alkyl ester of phthalic acid or a high boiling petroleum distillate. Thus the total chromium content in the catalyst employed will range from 0.5 to the theoretical maximum for the pure carboxylate compound, e.g. 10.8% for chromium⁺³ octoate. In one exemplary embodiment, the Cr⁺³ concentration in the chromium⁺³octoate catalyst is from 4% to 8% by weight. The catalyst/solvent system can range in viscosity from very fluid to very viscous.

The chromium⁺³ octoate catalyst can be prepared in accordance with Example I of U.S. Pat. No. 3,968,135, which is herein incorporated in its entirety by reference. The chromium⁺³octoate concentration in the catalyst is 35% to 75%, with the balance being composed of the solvent. The solvent in the chromium⁺³ octoate catalyst is present to aid in the handling of the catalyst, i.e., make it more fluid, dispersible, dispensable, and contactable with the reactants in the reaction media, and is not an essential component.

The concentration of chromium complex catalyst in the total reaction media may be from 0.08% to 12.0% by weight, or from 0.1% to 10% by weight, or from 0.5% to 8% by weight, all based on the combined weight of the reactants.

### Rheology Modifiers

Controlling the rate of polymerization and the rate of foaming due to the blowing agent is important to the forming of good quality foams, particularly foams that depend on a vertical substrate for support. It is also desirable that the first and second part of the foamable compositions have the same or nearly the same viscosity to achieve proper mixing of the first part components with the second part components. A 1:1 ratio promotes easy mixing of the components of the first part and the second part. For this reason, an optional but desirable component of the foaming composition is a rheology modifier—also known as a thixotrope—that can affect the flow properties of a liquid. A thixotropic mixture has high viscosity at low shear and lower viscosity when sheared (e.g., shaken or stirred). In foam compositions of various exemplary embodiments, rheology modifiers help keep the reactants in place until the foaming and polymerization reactions are complete or at least sufficiently progressed. The rheology modifier may be present in an amount up to 50% by weight of the dry foam composition. Preferably, the amount of rheology modifier present is 0.1% to about 20% by weight, based on the dry foamable composition, depending upon the nature of the modifier. Rheology modifiers may be divided into five different major groups: cellulosic derivatives, polyamides, carboxyl-containing acrylics, associative thickeners, and inorganics like clay and silica. See. e.g. Werner Blank presentation at: http://www.wernerblank.com/pdfiles/rheology.pdf.

Cellulosic derivatives may operate by any of several mechanisms, including contribution to hydrodynamic volume, chain entanglement, and flocculation depletion. Suitable agents for use in the foamable composition include methyl cellulose, ethyl cellulose, hydroxyethyl cellulose (e.g., Cellosize™ available from Union Carbide). Useful carboxylacrylates include alkaline swellable polyacrylates (e.g., Paragum 500 available from ParaChem), sodium polyacrylates (e.g., Paragum 104 available from Para-Chem).

Associative thickeners may affect the rheology by adsorption (e.g. hydrophobic or ion-dipole), inter- or intra-molecular self association, or micelle formation. Useful associative thickeners include those classed as hydrophobically-modified ethoxylated urethanes (HEUR type) including those sold under the tradenames Acrysol™ (RM, TT and QR types at least Dow Chemical, Midland, Mich.), and KStay 700 (King Industries, Norwalk, Conn.); as hydrophobically-modified alkalai-swellable emulsions (HASE-type); a hybrid known as HEURASE-type; and hydrophobically-modified hydroxyethyl cellulose (HMHEC-type).

Many rheology modifiers are inorganic minerals, clays, or modified clays. Clay is common name for a wide variety of weathered mineral or igneous rock, largely feldspar. Various classification schemes, such as the Nickel-Strunz classification, divide up mineral clays according to composition and/or structure. Suitable rheology modifiers may be found in the kaolinite group, the smectite or montmorillonite group, and the illite group. Generally, these groups contain sheets or layers formed of specific tetrahedral and/or octahedral structures of aluminum and silicon oxides. The layers or platelets are held together by ionic bonds with charged ions (usually cations) located between the layers. The Nickel-Strunz classification (version 10) divides silicates (group 9) into nine different subcategories, the most useful being phyllosilicates (group 9E), which itself is divided into nine subcategories, the two most useful being 9EC (with mica sheets) and 9ED (with kaolin layers). Exemplary clays from these groups include kaolin, montmorillonite or smectite, talc, mondorite, nontronite, muscovite, vermiculite, saponite, hectorite, rectorite, and minnesotaite. Bentonite is a useful impure clay largely containing montmorillonite.

It is the layers or “platelets” of phyllosilicates that give them many of their properties, including the plasticity for use as pottery. When the layers are of thickness dimensions in the few nanometer range, they are often referred to as nanoclays. An example is the NANOLIN DK series of nanoclays available from Zhejiang Fenghong Clay Chemicals Co., Ltd., which are made from highly purified smectite that exhibits ultra-fine phase dimensions. The size of these nanoclays is typically in the range of 1-100 nm while being fully dispersed, with the average fully dispersed thickness of platelet being around 25 nm; the aspect ratio being 100-1000.

Modified clays are formed when various processes are used to separate and expand the layers or platelets. Intercalation, exfoliation, and fuming are processes that modify the layered structure. Intercalation inserts a polymer or other molecule between the platelet layers to isolate them, but without much physical separation. Exfoliation, on the other hand, inserts a polymer or molecule and expands the space between layers by 10-20 fold. Fuming is a flaming process that introduces hydroxyl groups onto the surface of the silica structures.

A specific type of modified clay that impacts hydrophilicity and solubility are those clays known as “organoclays.” Organoclays are modified by the replacement of the cation (usually sodium) between layers with alkylammonium (˜N+) compounds, a type of surfactant. The nitrogen end of the quaternary amine, the hydrophilic end, is positively charged, and ion exchanges onto the clay platelet for sodium or calcium. The amines used generally have long chain R groups with 12-18 carbon atoms, making them more compatible with many organic polymers. After about 30 percent of the clay surface is coated with these amines it becomes hydrophobic and, with certain amines, organophilic. Additionally, exfoliation of organoclays becomes easier since there is a larger distance between the platelets due to the bigger size of the ammonium salts compared to sodium ions.

Some non-limiting examples of the many suitable clay-based rheology modifiers include Laponite and Garamite 1958 (Southern Clay Products). Some non-limiting examples of the many suitable rheology modifiers based on fumed alumina or fumed silica include Aerosil and Cab-O-sil® TS-720 (Cabot Corp.)

In the spray foam of various exemplary embodiments, the first or second part may also include other optional, additional components such as, for example, foam promoters, opacifiers, accelerators, foam stabilizers, dyes (e.g., diazo or benzimidazolone family of organic dyes), color indicators, gelling agents, flame retardants, biocides, fungicides, algaecides, fillers, and/or conventional blowing agents. It is to be appreciated that a material will often serve more than one of the aforementioned functions, as may be evident to one skilled in the art, even though the material may be primarily discussed only under one functional heading herein. The additives are desirably chosen and used in a way such that the additives do not interfere with the mixing of the ingredients, the cure of the reactive mixture, the foaming of the composition, or the final properties of the foam.

As described above, it is often desirable that the first part and the second part of the composition have the same or nearly the same viscosity to permit easy application and mixing of the components of the first part and second part. The thickening agents may be present in the first part and the second part, respectively, in an amount up to 50% by weight (i.e. 0-50%) of the dry foam composition. In at least one exemplary embodiment, the amount of thickening agent present in the first part is from 0.1 to 10.0% by weight, based on the dry foamable composition, and the amount of thickening agent present in the second part is from 0.1 to 10.0% by weight, based on the dry foamable composition, depending upon the nature of the thickening agent. Rheology modifiers should be selected so as not to adversely affect the properties of the foams, such as the proportion of closed vs. open cells.

### Optional Additives

The first and/or second parts of the composition may also include other optional, additional components such as, for example, foam promoters, opacifiers, accelerators, foam stabilizers, colorants or dyes (e.g., diazo or benzimidazolone family of organic dyes), color indicators, gelling agents, flame retardants, coupling agents/wetting agents/adhesion promoters (e.g., silanes), antioxidants, UV stabilizers, biocides, fungicides, algaecides, corrosion inhibitors, and/or fillers. It is to be appreciated that a material will often serve more than one of the aforementioned functions, as may be evident to one skilled in the art, even though the material may be primarily discussed only under one functional heading herein. The additives are desirably chosen and used in a way such that the additives do not interfere with the mixing of the ingredients, the cure of the reactive mixture, the foaming of the composition, or the final properties of the foam. Some examples may include carbon black, solid rubber particles, hollow (glass) microspheres, glass fibers, and inert polymer particles.

For example, fillers may be added to epoxy foam formulations to lower cost, add color, reduce exotherm, and control shrinkage rates. Fillers in the form of fine particles (for example, carbon black or fumed silica) may also serve as nucleating agents and flow control additives. Small particles provide sites for heterogeneous nucleation, which allow for initiation and subsequent growth of foam cells when certain blowing agent types are used. In heterogeneous nucleation, gas molecules driven by supersaturation preferentially form nucleation sites on the solid/fluid interfaces of the nucleating agent. The ultimate cell size is determined by other factors including the exotherm, the rate of cure, the amount of blowing agent, and interactions between the epoxy and other formulation components. Although a number of suitable additives are known in the art, a particular preferred additive of various exemplary embodiments is a rheology modifying additive or filler formulated within either or potentially both of the first and second parts which causes both parts to be shear-thinning.

### Method of Use

The exemplary spray foams of the disclosed embodiments can be used in the same manner as any traditional spray foam for foam-in-place situations. The components are formulated into a foamable composition, typically though not necessarily in two parts as a first part and a second part. In formulations contemplated by the general inventive concepts, the reactive components—e.g. the epoxy resin and the carboxylic acid should typically be kept separated until use. Separation may be accomplished by physically formulating two parts, or by encapsulation in shells as is known in the art. The shells may be disrupted by shear, heat, sonication or other suitable means, thereby releasing the reactive ingredients.

The foamable composition is then applied, typically by spraying and/or extruding the foamable composition, to a desired substrate. Suitable substrates include, but are not limited to, wall cavities (closed or open), gaps or crevices between building structure components like studs and wall boards, studs and window or door frames, wallboards and joists, wallboard-to-wallboard, joists and studwalls, flooring and studwalls, etc. The foamable composition may be applied through an application device, such as a spray gun, wherein the first part and second part may be intermixed in the device as the foamable composition exits the application device or is otherwise applied.

Upon application, the foam must set and cure rapidly. This is especially true in vertical substrate applications. The rate of polymerization reaction between the epoxy resin and the carboxylic acid functional groups should be timed to coincide with the blowing reaction in order to form good foams with consistent closed cell content (e.g., at last 80% closed cell, 90% closed sell, or 95% closed cell). The rheology modifiers help the foam stay in place for a time sufficient to allow the foam to form and set before the force of gravity pulls the foam downward from the site of application. Typically, foams of the disclosed exemplary embodiments will cure to the touch within 180 seconds or less, 120 seconds or less, 90 seconds or less, or preferably within 60 seconds or less. “Cured to the touch” means that the surface or skin of the foam is sufficiently formed to hold the foam in place and prevent the escape of foaming gas, and of sufficiently low tackiness that light tactile pressure does not cause the foam to stick to the hand or finger. Typically, foams of the disclosed exemplary embodiments will fully cure to foamed product within 8 hours, within 6 hours, within 4 hours, or within 2 hours.

### EXAMPLES

The following examples serve to further illustrate the disclosed exemplary embodiments.

### Example 1

### Preparation

Foamable compositions are prepared in two parts according to formulations set forth in Table 1 below. Each composition is allowed to foam by mixing the two parts together on a substrate.

TABLE 1
Formulations (in weight percent of total composition)

| | Equiv | Sample | Sample | Sample | Sample |
|---|---|---|---|---|---|
| Ingredient | # | A | B | C | C |
| Epoxy resin | | | | | |
| EPON 828 | 192 | 27 | | 27 | |
| ERL4221 | 143 | | 22 | | 22 |
| Polycarboxylic | | | | | |
| acid | | | | | |
| EMPOL 1046 | 290 | 43 | 45 | | |
| EMPOL 1016 | 273 | | | 40 | 40 |
| Chromium (III) | | | | | |
| Catalyst | | | | | |
| HYCAT 2000S | | 3 | | | 12 |
| HYCAT OA | | | 6 | 4 | |
| Blowing Agent | | | | | |
| FEA-1100 | | 15 | | 17 | |
| HFC 254a | | | 12 | | 12 |
| Rheology | | | | | |
| Modifier | | | | | |
| Garamite 1958 | | 10 | | | 12 |
| Laponite | | | 12 | 10 | |
| Other additives | | 2 | 3 | 2 | 2 |
| Total | | 100 | 100 | 100 | 100 |
| Acid/epoxide | | 1.054 | 1.009 | 1.042 | 0.952 |
| equivalents ratio | | | | | |

The foregoing description of the various exemplary aspects and embodiments of the present disclosure have been presented for purposes of illustration and description of the general inventive concepts. It is not intended to be exhaustive of all embodiments or to limit the claims to the specific aspects disclosed. Modifications or variations are possible in light of the above teachings and such modifications and variations may well fall within the scope of the general inventive concepts as determined by the appended claims when interpreted in accordance with the breadth to which they are fairly, legally, and equitably entitled.

What is claimed is:

1. A two-part foamable composition comprising:
a first part comprising:
an epoxy resin;
a second part comprising:
a polycarboxylic acid; and
a chromium (III) catalyst complex capable of catalyzing a reaction between the epoxy resin and the carboxylic acid at ambient temperature; and
the composition further comprising a blowing agent for initiating a foaming reaction.

2. The foamable composition of claim 1, wherein the epoxy resin comprises an aliphatic backbone selected from polyesters and polyethers.

3. The foamable composition of claim 1, wherein the epoxy resin comprises an aromatic backbone.

4. The foamable composition of claim 1, wherein the carboxylic acid is a polyacrylate.

5. The foamable composition of claim 1, wherein the blowing agent is a low-boiling point hydrocarbon.

6. The foamable composition of claim 1, wherein the blowing agent is selected from FEA-1100 and HFC 254.

7. The foamable composition of claim 1, further comprising a rheology modifier.

8. The foamable composition of claim 7, wherein the rheology modifier is selected from associative thickeners, inorganic clays, and modified clays.

9. A method of sealing or insulating part of a building, the method comprising applying a foamable composition according to claim 1 to the part of the building, initiating a foaming reaction, and permitting the epoxy resin and the polycarboxylic acid to covalently react to form a foam.

10. The method of claim 9, wherein the part of the building is a seam or crevice between two structural components of the building.

11. The method of claim 9, wherein the part of the building is a cavity or open space framed by a plurality of structural components of the building.

12. The method of claim 9, wherein the foamable composition is applied by spraying.

13. The method of claim 9, wherein the foamable composition is applied by extruding.

14. The method of claim 9, wherein the foaming reaction is initiated by applying heat.

15. The method of claim 9, wherein the foam cures to the touch in less than 120 seconds.

16. The method of claim 15, wherein the foam cures to the touch in less than 90 seconds.

17. A foam product comprising:
cells formed from the reaction product of an epoxy resin crosslinked to a polycarboxylic acid crosslinking agent, wherein the polycarboxylic acid crosslinking agent is a polyacrylic acid; and
a blowing agent disposed within at least some of the cells,
wherein the reaction between the epoxy resin and the polycarboxylic resin is catalyzed by a chromium (III) catalyst.

18. The foam product of claim 17, wherein the cells are at least 85% closed.

19. The foam product of claim 17, wherein the epoxy resin comprises an aliphatic backbone selected from polyesters and polyethers.
